(19) United States
(12) Patent Application Publication
(10) Pub. No.: US 2006/0115233 A1
(43) Pub. Date: Jun. 1, 2006

(54) Display methods for digital video disk recorders and integrated menus for same

(76) Inventors: Chun-Lung Liu, Hualien Hsien (TW); Wei-Hung Huang, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/001,707

(22) Filed: Nov. 30, 2004

(51) Int. Cl. H04N 5/93

(52) U.S. Cl. 386/52

(57) ABSTRACT

Menu display methods for a DVD recorder. Title list and editing functions are displayed in an integrated menu for a digital video disk in a digital video disk recorder. The integrated menu is displayed for executing playback and editing functions.

### BACKGROUND

The invention relates to menu display methods for digital video disk recorders, and in particular to displaying an integrated menu for a digital video disk recorder.

Playback and editing functions are important for a digital video disk recorder (DVD recorder). When a disk has been placed in a DVD recorder, a title menu may be displayed for playback and editing operations. The title menu lists the content of a disk. Disk content is generally divided into several parts, called titles, and each title has one or more chapters. Every title can be selected for playback, for example, as a start point for playback. If the content of a disk is to be edited, a switch from a title menu to an editing menu must be first executed. After switching the menu, an editing menu is displayed for executing editing functions. If playback functions are frequently interchanged with editing functions, menu switching is executed repeatedly, causing inconvenience.

FIG. 1 is a flowchart of a conventional method of menu display for a DVD recorder. A title menu, shown in FIG. 2a, is displayed (step S10). The content of a disk is divided into several titles, each having one or more chapters. A title displayed on the playback menu may be selected for playback (step S12). Sometimes, a chapter included in the title is selected as a start point for playback. If the content of the disk is to be edited, a specific key is pressed to switch menus (step S14).

After the specific key is pressed, an editing menu, shown in FIG. 2b, is displayed (step S16). The disk can be edited through the editing menu (step s18). For editing, the title to be edited is selected first and then the editing menu is activated for selection of editing options. As can be seen, a title displayed on the left side of FIG. 2b and an editing function displayed on the right side of FIG. 2b are selected. The selected editing function, such as deletion or division, can be applied to the selected titles. In conventional methods, only one title can be selected for editing at one time, such as deleting a title. Furthermore, the title information displayed on the right side of FIG. 2a is covered by the editing menu, and therefore is invisible in FIG. 2b. To return to playback functions, a specific key must again be pressed to switch menus (step S20). Here, the switch between title and editing menus can be accomplished by one particular key or different keys. However, it is very awkward for users to switch back and forth between title and editing menus as they are editing multiple titles stored in the related-art recorders.

### SUMMARY

In an exemplary embodiment of a menu display method for digital video disk recorders, title list and editing functions are displayed in an integrated menu. The integrated menu is displayed for listing, editing, and playback titles recorded on a digital video disk in a digital video disk recorder.

### DESCRIPTION OF THE DRAWINGS

The present invention can be more fully understood by reading the subsequent detailed description and examples with references made to the accompanying drawings, wherein:

FIG. 1 is a flowchart of a conventional method of menu display for a DVD recorder.

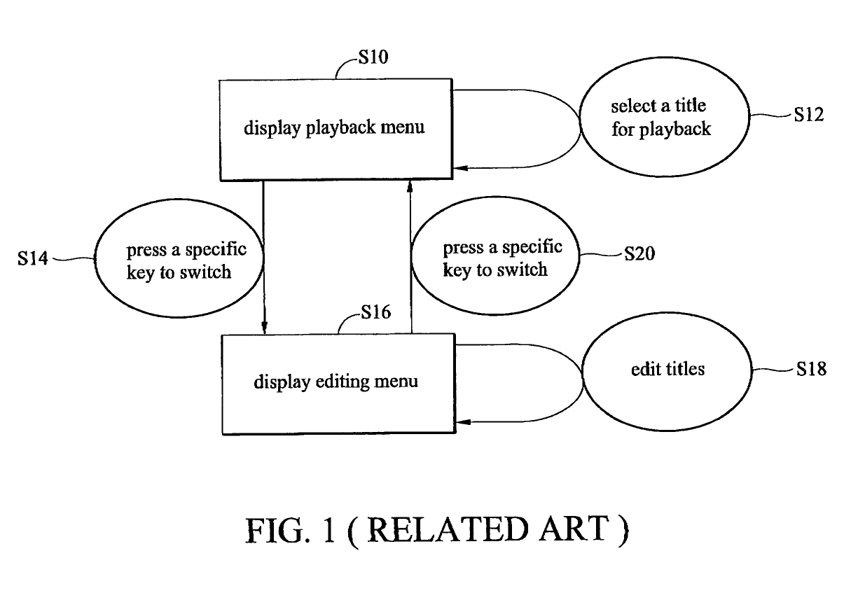

FIG. 2a is a diagram of an embodiment of a conventional method of displaying a playback menu for a DVD recorder.

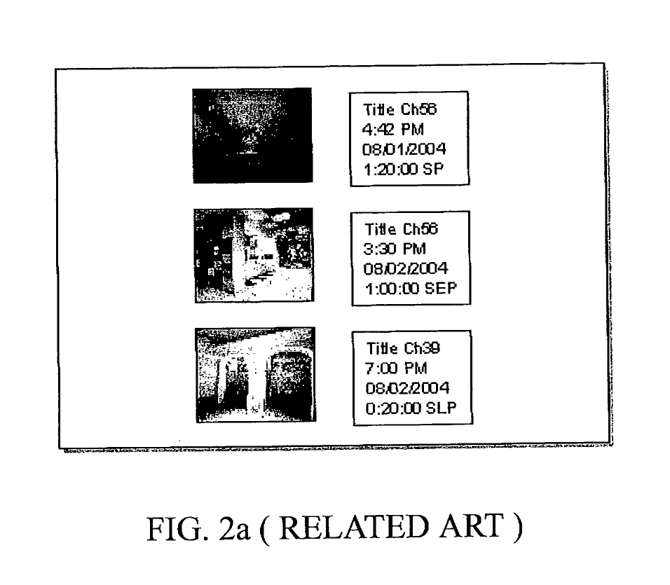

FIG. 2b is a diagram of an embodiment of a conventional method of displaying an editing menu for a DVD recorder.

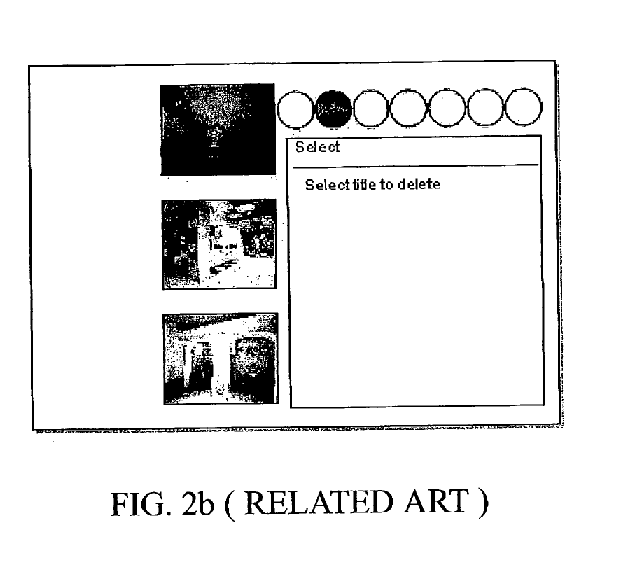

FIG. 3 is a flowchart of an embodiment of an integrated menu display method for a DVD recorder.

FIG. 4 is a diagram of an embodiment of an integrated menu for a DVD recorder.

FIG. 5 is a block diagram of an embodiment of a DVD recorder.

### DESCRIPTION

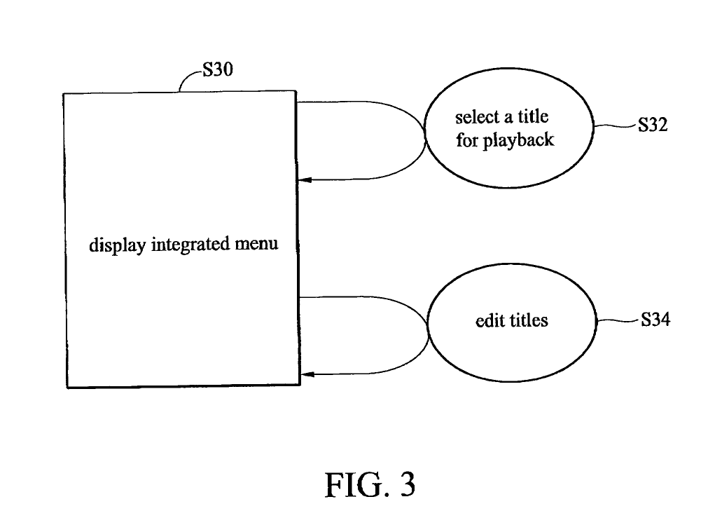

Methods of menu display for a DVD recorder are provided. FIG. 3 is a flowchart of an embodiment of an integrated menu display method for a DVD recorder. A title list and editing functions are provided in an integrated menu for a digital video disk in a DVD recorder (step S30). The integrated menu is displayed for various operations.

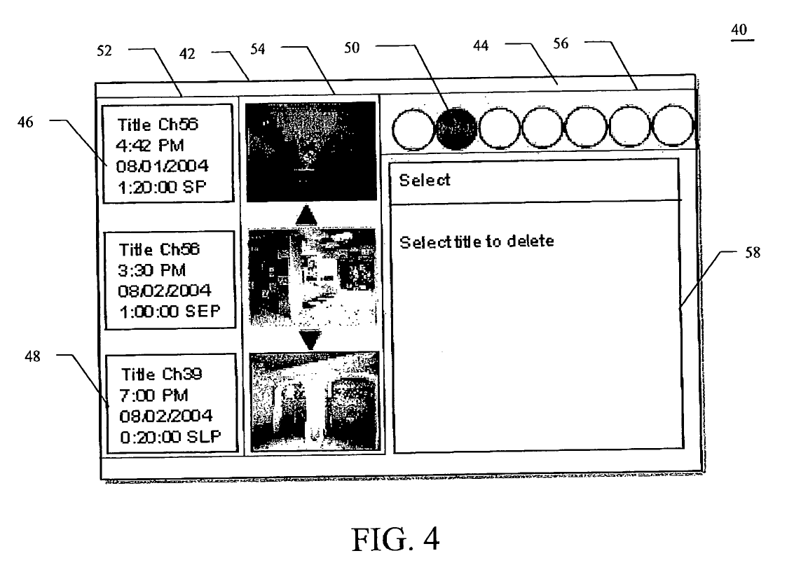

The content of the digital video disk can be divided into titles and displayed on the integrated menu as shown on the left of FIG. 4. One or more titles, displayed on the integrated menu can be selected for playback and editing (step S32). One of the editing options displayed on the integrated menu is selected for applying the corresponding function to the selected title or titles (step S34). The selections can be accomplished by an input device. The input device may be a remote control or a keypad on the DVD recorder. Thus, repeated menu switching may be eliminated, and the title list, playback and editing functions for content recorded on a disk can be accomplished via such an integrated menu.

Additionally, an integrated menu is provided for digital home appliances such as digital video disk (DVD) recorders, digital VHS recorders, and the like. FIG. 4 is a diagram of an embodiment of an integrated menu for a DVD recorder. The integrated menu 40 comprises a title list section 42 and an editing section 44. The title list section 42 provides browse functions for a digital video disk in a digital video disk recorder, which comprises a title information area 52 and a preview area 54. The preview area 54 contains one or more windows displaying thumbnail pictures that may be still images or moving pictures representing the titles of program recorded on a disk. If the number of windows is insufficient to display all titles at the same time, a user can press up/down button to scroll the thumbnail pictures and thereby browse through the entire disk. The title information area 52 provides one or more windows to display corresponding title information including title name, title length, and recording date. The editing section 44 provides multiple icons, identified by reference numeral 56 in FIG. 4, each of which represents an editing option available for the digital video disk. The editing section 44 also comprises an editing information area 58 to show messages corresponding to the editing function being selected. Among these editing options, a special function 50 is provided to select multiple titles at one time. In some embodiments, a user may press the up or down button to search for a title to be edited and press the left or right button to highlight the special function 50 for selecting the title. Repeating the above steps, multiple titles can be selected and added to a title list to be edited without frequently turning on and off the editing menu. Once the titles to be edited are selected completely, a user may press the left or right button to highlight the other editing icons 56, choosing a desired editing option therefrom. For instance, two or more titles are selected and erased at one time through the integrated menu 40 to free up disk space.

Here, as mentioned, the content of the digital video disk can be divided into titles and displayed in the title list section 42. One title displayed in this section 42 may be selected as a playback start point, such as “Title Ch56” 46, as shown in FIG. 4. One or more titles in the title list section 42 and one editing function on the editing section 44 are selected for application of the selected editing function thereto. The selections can be accomplished by key input from an input device. The input device can be a remote control or a keypad on the digital video disk recorder.

For example, an integrated menu 40 for a digital video disk recorder comprises a title list section 42 and an editing section 44. The content of the digital video disk is divided into several titles and displayed on the playback section 42. Every title of the disk content displayed on the integrated menu 40 can be selected as a start point for playback, such as “Title Ch56” 46 or “Title Ch39” 48. Multiple titles, such as channels 46 and 48, on the title list section 42 of the integrated menu 40 can be selected at one time. One editing function, such as “erase”, may be selected from the icons 56 that denote various options and are rendered on the editing section 44. The selected editing function “erase” can be applied to the selected channels 46 and 48. The selections can be accomplished by key input from an input device, such as a remote control or a control on the digital video disk recorder.

Compared to conventional methods, the integrated menu 40 provides title list, playback, and editing functions on a screen at the same time, thus reducing repeated switching between menus. Also, the integrated menu 40 displays the title information area 52 and the editing section 44 concurrently so title information is visible during conducting the editing operations. Furthermore, the exemplary embodiment can apply editing functions to multiple titles of the disk, while the conventional method can only apply editing functions to one title of a disk at a time. Thus, the disclosed methods and integrated menus may potentially resolve the inconvenience of conventional menu display methods for a DVD recorder.

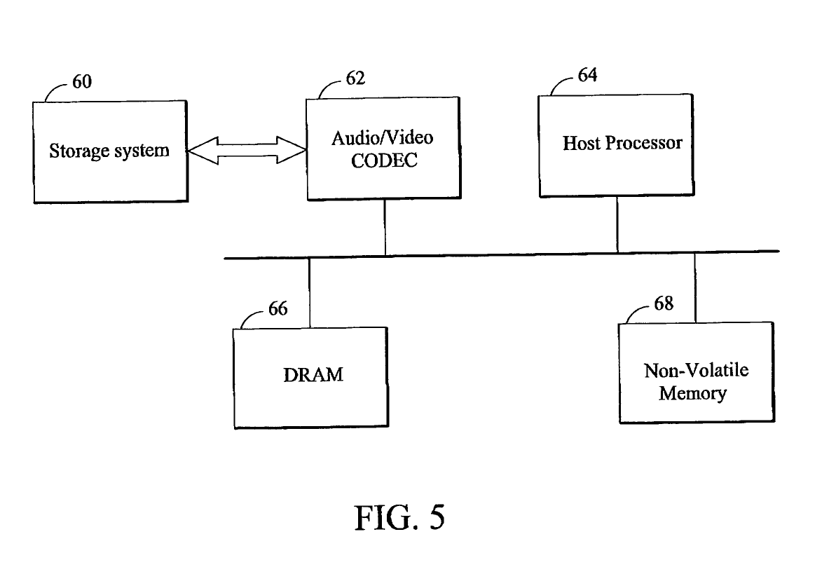

FIG. 5 is a block diagram of an embodiment of a DVD recorder. The DVD recorder includes a storage system 60, an audio/video CODEC 62, a host processor 64, a DRAM 66, and a non-volatile memory 68. The storage system 60 comprises an optical storage device for recording/reproducing data to/from a DVD disk. The audio/video CODEC 62 is responsible for decoding audio and video data from the storage system 60, and for encoding audio and video data to be recorded on a disk through the storage system. The DRM 66 is a program and data buffer when the DVD recorder is operating. The non-volatile memory 68 stores code, which, when executed by the host processor 64, causes the processor 64 to control this recorder and enables such a DVD recorder to effect the integrated menu 40. In some embodiments, the host processor 64 may be integrated with the audio/video CODEC 62.

Methods of the present disclosure, or certain aspects or portions of embodiments thereof, may take the form of program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing and embodiment of the disclosure. The methods and apparatus of the present disclosure may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A menu display method for a digital video disk recorder, comprising:
providing title list and editing functions at the same time in an integrated menu for a digital video disk in a digital video disk recorder, wherein the editing functions comprises a special function for selecting multiple titles; and
displaying the integrated menu.

2. The menu display method for a digital video disk recorder as claimed in claim 1, wherein the content of the digital video disk is divided into at least one title to be displayed on the integrated menu.

3. The menu display method for a digital video disk recorder as claimed in claim 2, wherein one title displayed on the integrated menu is selected as a start point for playback.

4. The menu display method for a digital video disk recorder as claimed in claim 3, wherein the selection is accomplished by an input device.

5. The menu display method for a digital video disk recorder as claimed in claim 4, wherein the input device is a remote control or a keypad on the digital video disk recorder.

6. The menu display method for a digital video disk recorder as claimed in claim 2, further comprising:
selecting one or more titles by the special function, and one editing function displayed on the integrated menu;
applying the selected editing function to the selected titles.

7. The menu display method for a digital video disk recorder as claimed in claim 6, wherein the selection is accomplished by an input device.

8. The menu display method for a digital video disk recorder as claimed in claim 7, wherein the input device is a remote control or a keypad on the digital video disk recorder.

9. An integrated menu for a digital video disk recorder, comprising:
a title list section, providing title list and playback functions for a digital video disk in a digital video disk recorder; and
an editing section, providing editing functions for the digital video disk, wherein the editing functions comprises a special function for selecting multiple titles.

10. The integrated menu for a digital video disk recorder as claimed in claim 9, wherein the content of the digital video disk is divided into at least one title to be displayed on the title list section.

11. The integrated menu for a digital video disk recorder as claimed in claim 10, wherein one title displayed in the title list section is selected as a playback start point.

12. The integrated menu for a digital video disk recorder as claimed in claim 11, wherein the selection is accomplished by key input from an input device.

13. The integrated menu for a digital video disk recorder as claimed in claim 12, wherein the input device is a remote control or a keypad on the digital video disk recorder.

14. The integrated menu for a digital video disk recorder as claimed in claim 10, wherein one or more titles in the title list section are selected by the special function, and one editing function in the editing section is selected for application of the selected editing function thereto.

15. The integrated menu for a digital video disk recorder as claimed in claim 14, wherein the selection is accomplished by key input from an input device.

16. The integrated menu for a digital video disk recorder as claimed in claim 15, wherein the input device is a remote control or a keypad on the digital video disk recorder.

17. A digital video disk recorder comprising:
a processor; and
a non-volatile memory storing code, which, when executed by the processor, causes the processor to provide an integrated menu rendering a title list section and an editing section at the same time;
wherein the title list section comprises a title information area and a preview area;
wherein the editing section provides a plurality editing options available for a digital video disk, and the editing options comprise a special function for selecting multiple titles at one time;
wherein the title information area is visible when the editing section is activated.
